(19) United States
(12) Patent Application Publication
(10) Pub. No.: US 2010/0157012 A1
(43) Pub. Date: Jun. 24, 2010

(54) IMAGE PROCESSING MATCHING POSITION AND IMAGE

(75) Inventors: Wong Tzy Huei, Singapore (SG); Ang Hwee San, Singapore (SG); Joanne Goh Li Chen, Singapore (SG); Sutono Gunawan, Singapore (SG)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/638,924

(22) Filed: Dec. 15, 2009

(30) Foreign Application Priority Data
Dec. 24, 2008 (JP) 2008-328328

(51) Int. Cl. B41J 2/435

(52) U.S. Cl. 347/250

(57) ABSTRACT

An apparatus includes: a position detection section which detects the position of the apparatus at predetermined detection timing; a light source section which emits light at light emitting timing synchronized with the detection timing; an image-taking section which takes the image of a photographic subject by using the emitted light; and an image processing section which matches the position data indicating the detected position of the apparatus and the image data obtained by the image-taking.

### CROSS-REFERENCES TO RELATED APPLICATIONS

Priority is claimed under 35 U.S.C.§119 to Japanese Application No. 2008-328328 filed on Dec. 24, 2008 which is hereby incorporated by reference in its entirety.

### BACKGROUND

1. Technical Field

The present invention relates to the technology of performing image processing which matches a position and an image.

2. Related Art

There is known an apparatus which has a position sensor and a linear image sensor, functions as a pointing device (a mouse), and also functions as an image scanner (for example, JP-A-11-345074). In this apparatus, image data are obtained by taking an image while moving the apparatus, and the obtained plural columns (rows) of the image data and the position data indicating the position detected by the position sensor are matched. The image data are synthesized on the basis of the matched position data, so that the image data indicating one two-dimensional image are generated.

In the above-mentioned technology, there was room for improvement in the correspondence precision of the position data indicating a position and the image data indicating an image. In a case where the correspondence precision of the position data and the image data is low, for example, the quality of the image which is generated by the synthesis of the image data based on the position data cannot be sufficiently increased.

Further, such a problem is not limited to the case of synthesizing the image data on the basis of the position data, but was a problem common to the case of matching the position data indicating a position and the image data indicating an image.

### SUMMARY

An advantage of some aspects of the invention is that it provides improvement in the correspondence precision of the position data indicating a position and the image data indicating an image.

The invention can be realized as the following modes and applications.

### Application 1

According to Application 1 of the invention, there is provided an apparatus including: a position detection section which detects the position of the apparatus at predetermined detection timing; a light source section which emits light at light emitting timing synchronized with the detection timing; an image-taking section which takes the image of a photographic subject by using the emitted light; and an image processing section which matches the position data indicating the detected position of the apparatus and the image data obtained by the image-taking.

In this apparatus, since the light source section emits light at the light emitting timing synchronized with the position detection timing by the position detection section, the image of the subject is taken by using the emitted light, and the position data indicating the detected position of the apparatus and the image data obtained by the image-taking are matched, the correspondence precision of the position data indicating a position and the image data indicating an image can be improved.

### Application 2

In the apparatus according to Application 1, the image-taking section may also have an area image sensor which includes a plurality of pixel groups having different exposure periods from each other, and the light emitting timing may also be the timing synchronized with the detection timing in the period in which all pixel groups of the area image sensor are in an exposure state.

In this apparatus, also in a case where the image-taking is performed by using the area image sensor which includes a plurality of pixel groups having different exposure periods from each other, since the light emitting timing of the light source section is set in the period in which all pixel groups of the area image sensor are in an exposure state, distortion in the image obtained by the image-taking can be suppressed.

### Application 3

In the apparatus according to Application 1 or 2, the detection timing may also be the timing of every preset time elapse.

In this apparatus, also in the case of detecting the position of the apparatus by using the position detection section in which the detection timing is the timing of every preset time elapse, by making the light source section emit light at the light emitting timing synchronized with the position detection timing by the position detection section, the correspondence precision of the position data indicating a position and the image data indicating an image can be improved.

### Application 4

The apparatus according to any one of Application 1 to 3 may further include an interface section which is connected to a computer; and a user instructions input section which transmits a signal according to the detected position of the apparatus to the computer as a signal indicating user instructions.

In this apparatus, in the apparatus having the function of transmitting the signal according to the position of the apparatus detected by the position detection section to the computer as a signal indicating user instructions, the correspondence precision of the position data indicating a position and the image data indicating an image can be improved.

Further, the invention can be implemented in various aspects, for example, in the forms of a method and apparatus for performing image processing, a method and apparatus for generating an image, a computer program for realizing the functions of these methods and apparatuses, a recording medium in which the computer program is recorded, or the like.

### BRIEF DESCRIPTION OF THE DRAWINGS

The invention will be described with reference to the accompanying drawings, wherein like numbers reference like elements.

FIG. 1 is an explanatory view showing the appearance of a mouse scanner in an embodiment of the invention.

FIG. 2 is a block diagram showing the functional configuration of a computer system which includes the mouse scanner.

FIG. 3 is an explanatory view showing one example of a timing chart in a scanner mode.

FIG. 4 is an explanatory view showing the configuration of a strobe circuit.

### DESCRIPTION OF EXEMPLARY EMBODIMENTS

Next, a mode for carrying out the invention is explained in the following order on the basis of an embodiment.

### A. Embodiment

### B. Modified Examples

### A. Embodiment

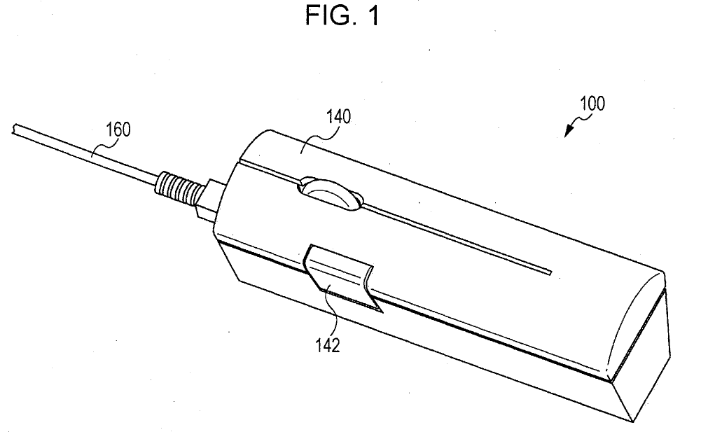

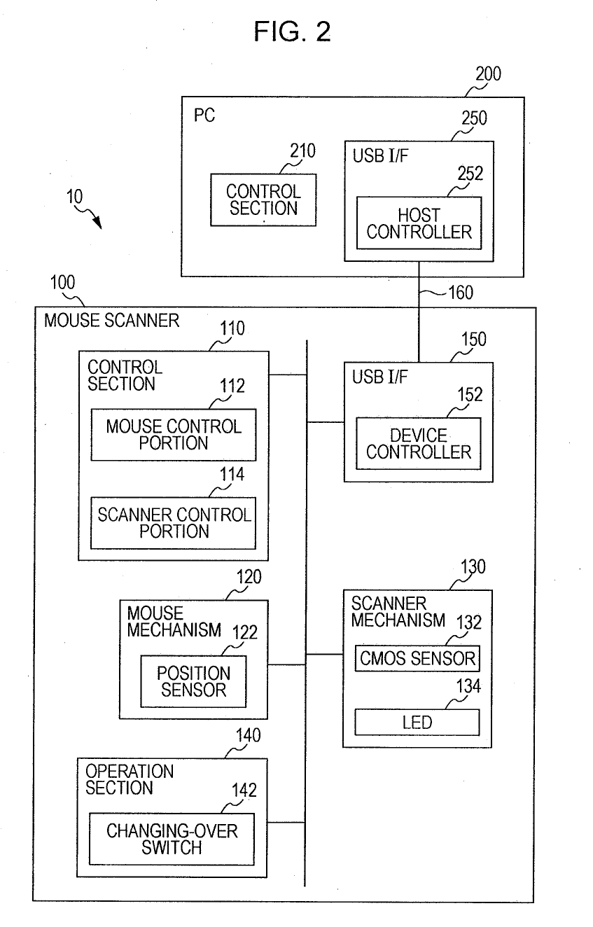

FIG. 1 is an explanatory view showing the appearance of a mouse scanner 100 in an embodiment of the invention, and FIG. 2 is a block diagram showing the functional configuration of a computer system 10 which includes the mouse scanner 100. As shown in FIG. 2, the computer system 10 includes the mouse scanner 100 and a personal computer (hereinafter referred to as a “PC”) 200.

The mouse scanner 100 of this embodiment has a mouse function serving as a user instructions input device and an image scanner function serving as an image read-out device (image generation device) and operates while changing over an operation mode, between a mouse mode which provides the mouse function and a scanner mode which provides the image scanner function.

The mouse scanner 100 includes a mouse mechanism 120 which realizes the mouse function, a scanner mechanism 130 which realizes the image scanner function, an operation section 140 such as a button or a wheel, a USB interface (USB I/F) 150 which includes a device controller 152, and a control section 110 which controls the entirety of the mouse scanner 100. Also, the PC 200 includes a USB interface (USB I/F) 250 which includes a host controller 252, and a control section 210 which controls the entirety of the PC 200.

The mouse scanner 100 of this embodiment and the PC 200 are a device corresponding to a USB interface. The USB interface 150 of the mouse scanner 100 and the USB interface 250 of the PC 200 are connected to each other through a USB cable 160. In this state, the PC 200 functions as a USB host and the mouse scanner 100 functions as a USB device.

The mouse mechanism 120 of the mouse scanner 100 includes a position sensor 122 which detects its own position. The position sensor 122 is fixed to the mouse scanner 100, and the work of the position sensor 122 detecting its own position has substantially the same meaning as the detection of the position of the mouse scanner 100. The position sensor 122 outputs the position data indicating the position (a moving direction and a moving amount from a reference position) of the mouse scanner 100 at predetermined detection timing.

The scanner mechanism 130 of the mouse scanner 100 includes a CMOS sensor 132 serving as an area image sensor, and an LED 134 serving as a light source. The CMOS sensor 132 has a photodiode disposed at each pixel of a two-dimensional pixel array of 640 columns×480 rows and takes the image of a photographic subject, thereby obtaining an image. The CMOS sensor 132 adopts a so-called rolling shutter method and has exposure periods shifted for every pixel line as described below.

The control section 110 has a CPU and a memory, which are not shown in the drawing. The control section 110 reads and executes a given computer program in the memory, thereby functioning as a mouse control portion 112 which controls the operation of the mouse scanner 100 serving as a mouse, in a mouse mode, and functioning as a scanner control portion 114 which controls the operation of the mouse scanner 100 serving as an image scanner, in a scanner mode.

Specifically, the mouse control portion 112 transmits, in the mouse mode, the position data outputted by the position sensor 122 or a detection signal of the operation (the pushing of a button, or the like) of the operation section 140 by a user to the PC 200 as a signal indicating user instructions. The control section 210 of the PC 200 receives the signal indicating user instructions from the mouse scanner 100 and either moves the position of a pointer displayed on, for example, a display (not shown) or starts the execution of a given processing, in accordance with the contents of the received signal.

Also, the scanner control portion 114 controls, in the scanner mode, the CMOS sensor 132 or the LED 134 of the scanner mechanism 130 so as to take the image of a photographic subject which faces a window (not shown) provided at the bottom of the mouse scanner 100, thereby obtaining image data. Further, the scanner control portion 114 matches the position data outputted by the position sensor 122 and the obtained image data and transmits the matched position data and image data to the PC 200. Also, in the scanner mode, the scanner control portion 114 functions as an image processing section in the invention. The control section 210 of the PC 200 receives the position data and the image data from the mouse scanner 100 and performs an image synthesis processing (stitching) based on, for example, the position data. Here, the image synthesis processing which is called stitching is the processing which specifies the position relation between the plural pixels on the basis of the position data and generates an image representing a more extensive subject by synthesizing the plural images. In the scanner mode, by performing image-taking while moving the mouse scanner 100, and performing the stitching in the PC 200, the read-out of a broad subject becomes possible.

The operation section 140 of the mouse scanner 100 includes a changing-over switch 142 which receives the operation mode changing-over instructions by a user. In the mouse scanner 100 of this embodiment, if the changing-over switch 142 is pushed by a user during the operation in the mouse mode, the operation mode is changed from the mouse mode to the scanner mode. On the contrary, if the changing-over switch 142 is pushed by a user during the operation in the scanner mode, the operation mode is changed from the scanner mode to the mouse mode.

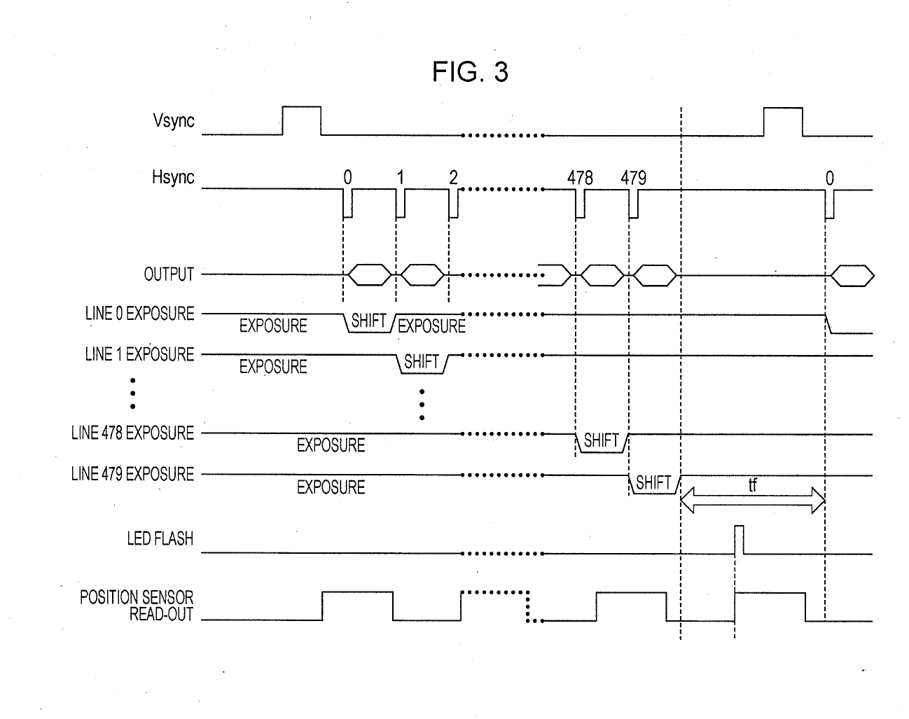

FIG. 3 is an explanatory view showing one example of a timing chart in the scanner mode. In the signals of FIG. 3, “Vsync” indicates a vertical synchronization signal of the CMOS sensor 132, “Hsync” indicates a horizontal synchronization signal of the CMOS sensor 132, “OUTPUT” indicates the image signal output timing of the CMOS sensor 132, “LINE i EXPOSURE” (i=0˜479) indicates the exposure timing of the i-th pixel line of the CMOS sensor 132, “LED FLASH” indicates the light emitting timing of the LED 134, and “POSITION SENSOR READ-OUT” indicates the position detection timing of the position sensor 122.

As shown in FIG. 3, the exposure periods of the CMOS sensor 132 are shifted for every line. That is, with respect to the 0th line (LINE 0) of the CMOS sensor 132, the period from the 0th falling edge to the 1st falling edge of the Hsync is a shift period for charge transfer, the other periods are exposure periods. Also, with respect to the 1st line (LINE 1), the period from the 1st falling edge to the 2nd falling edge of the Hsync is a shift period for charge transfer, the other periods are exposure periods. Also, in the period (the period tf of FIG. 3) from the shift period end of the 479th line (LINE 479) to the shift period start of the 0th line, all lines of the CMOS sensor 132 are in an exposure state.

The position sensor 122 detects the position of the mouse scanner 100 at the rising edge timing of the position sensor read-out signal shown in FIG. 3. In this embodiment, the position detection timing of the position sensor 122 is fixed in the timing of every 2-millisecond elapse.

The LED 134 emits light at the rising edge timing of the LED flash signal shown in FIG. 3. The light emitting duration of the LED 134 is calculated on the basis of a supposed maximum moving speed in the scanner mode of the mouse scanner 100 and a permissible pixel shift amount of the CMOS sensor 132 in the light emitting duration and set to be 100 microseconds in this embodiment. Further, in this embodiment, the light emitting timing of the LED 134 exists within the period tf in which all lines of the CMOS sensor 132 are in an exposure state, and is set to be the timing synchronized with the position detection timing of the position sensor 122.

Since in the light emitting period of the LED 134, all lines of the CMOS sensor 132 are in an exposure state, in all photodiodes of the CMOS sensor 132, an electric charge according to the color of the opposite subject is accumulated. The accumulated charge is shifted in the shift period of every line, and the image data corresponding to the entire of the CMOS sensor 132 are generated on the basis of the collected charge for all lines. Also, the position data indicating the position of the mouse scanner 100, which has been detected at the detection timing synchronized with the light emitting timing of the LED 134, is matched with the image data image-taken and generated by the light emitting of the LED 134.

As explained above, in the mouse scanner 100 of this embodiment, the light emitting timing of the LED 134 is set to be the timing synchronized with the position detection timing of the position sensor 122. Therefore, in this embodiment, the discrepancy of the position of the mouse scanner 100, which is indicated by the position data outputted by the position sensor 122, and the position of the mouse scanner 100 at the time of image-taking by the CMOS sensor 132 using the light emitting of the LED 134 can be minimized. Accordingly, in this embodiment, a correspondence precision of the position data indicating a position and the image data indicating an image can be improved. Therefore, for example, in the case of performing image synthesis on the basis of the position data matched with the image data as described above, the position discrepancy of the images can be minimized, so that the quality of a composite image can be improved.

Also, in the mouse scanner 100 of this embodiment, the LED 134 emits light in the period (the period tf of FIG. 3) in which all lines of the CMOS sensor 132 are in an exposure state. In a case where the light emitting period of the LED 134 corresponds to the shift period of any pixel (for example, the pixel of the 1st line), the relevant pixel cannot receive light, and the image signal of the relevant pixel remains as being a signal corresponding to that at the time of the previous light-emitting. At this time, in a case where the mouse scanner 100 moved between the previous light-emitting and this light-emitting, distortion occurs in the image. In the mouse scanner 100 of this embodiment, since the LED 134 emits light in the period in which all lines of the CMOS sensor 132 are in an exposure state, the distortion of the image which is obtained by image-taking can be suppressed.

Also, among image sensors, there is an image sensor capable of changing the period of the Vsync, and in the case of adopting such an image sensor, also by adjusting the period of the Vsync of the image sensor to the integral multiple of the period (in this embodiment, 2 milliseconds) of the detection timing of the position sensor 122, the correspondence precision of the position data and the image data can be improved. However, in this embodiment, even in a case where the period of the Vsync of the CMOS sensor 132 serving as the image sensor cannot be changed, the correspondence precision of the position data and the image data can be improved by synchronizing the light emitting timing of the LED 134 with the position detection timing of the position sensor 122.

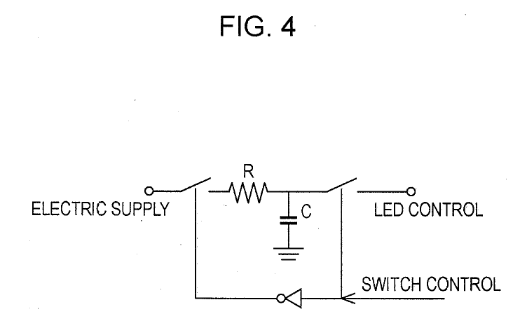

Also, as described above, in the mouse scanner 100 of this embodiment, in order to reduce the pixel discrepancy of the CMOS sensor 132 in the light emitting duration of the LED 134, the light emitting duration of the LED 134 is set to be a relatively short time such as 100 microseconds. Also, the LED 134 emits light using a USB bus power of 100 milliamperes, which is supplied from the PC 200 through the USB cable 160, as an electric source. Therefore, the scanner mechanism 130 has a strobe circuit shown in FIG. 4. In the period of time other than the light emitting duration of the LED 134, the switch of an electric supply side is connected, so that an electric charge is accumulated in a capacitor C. In the light emitting timing of the LED 134, the switch of an LED control side is connected, so that the electric charge accumulated in the capacitor C are supplied to the LED 134. Since the scanner mechanism 130 has such a strobe circuit, it is possible to supply an electric current necessary for the light emitting of the LED 134 in the relatively short light-emitting duration using the USB bus power as an electric source.

### B. Modified Examples

Also, the invention is not to be limited to the above-mentioned embodiment, but can be implemented in various aspects within the scope that does not depart from the essential points of the invention, and, for example, modifications as described below are also possible.

### Modified Example 1

Although the above-mentioned embodiment was described using the mouse scanner 100 as an example, the invention is not limited to the mouse scanner 100, but can be applied to an apparatus in general which has a position detection section, a light source section, an image-taking section, and an image processing section. For example, the invention can also be applied to a hand scanner which does not have a function as a mouse.

### Modified Example 2

In the mouse scanner 100 of the above-mentioned embodiment, the matched position data and image data are transmitted to the PC 200, and then the PC 200 performs the stitching by using the position data and the image data. However, a configuration may be adopted in which the mouse scanner 100 itself performs the stitching by using the position data and the image data and the image after image synthesis is supplied to the PC 200.

### Modified Example 3

The configuration of the computer system 10 in the above-mentioned embodiment is just an example, and various changes in the configuration of the computer system 10 can be made. For example, the size (pixel number) of the CMOS sensor 132 is not limited to that mentioned above. Further, the scanner mechanism 130 may also have, as the image-taking section, an area image sensor which is an image sensor other than the CMOS sensor 132 and includes a plurality of pixel groups having different exposure periods from each other. Further, also in a case where the scanner mechanism 130 has a line image sensor as the image-taking section, the invention is applicable. Further, the scanner mechanism 130 may also have a light source other than the LED 134. Further, the mouse scanner 100 does not need to be disposed corresponding to the USB interface, but may also be connected to the PC 200 by another interface.

### Modified Example 4

The timing chart (FIG. 3) in the scanner mode of the above-mentioned embodiment is just an example, and each signal in the timing chart can be variously changed. For example, although in this embodiment, the light emitting of the LED 134 is performed in the period tf subsequent to the shift period of LINE 479, the light emitting may also be performed in another timing, provided that it is the timing synchronized with the detection timing of the position sensor 122. Further, the light emitting timing of the LED 134 does not need to be necessarily within the period in which all lines of the CMOS sensor 132 are in an exposure state. However, if the light emitting timing of the LED 134 is set to be within the period in which all lines of the CMOS sensor 132 are in an exposure state, distortion in the obtained image can be suppressed. Further, the interval of the detection timing of the above-mentioned position sensor 122 or the length of the light emitting duration of the LED 134 can be variously changed.

### Modified Example 5

A portion of the configuration realized by hardware in the above-mentioned embodiment may also be replaced with software, and on the contrary, a portion of the configuration realized by software may also be replaced with hardware.

Further, in a case where a portion or all of the functions of the invention are realized by software, the software (computer program) can be provided in the form stored in a computer-readable recording medium. The computer-readable recording medium is not limited to a portable recording medium such as a flexible disc or a CD-ROM, but also includes an internal storage device in a computer, such as various RAMs or ROMs, or an external storage device fixed to a computer, such as a hard disc.

What is claimed is:

1. An apparatus comprising:
a position detection section which detects the position of the apparatus at predetermined detection timing;
a light source section which emits light at light emitting timing synchronized with the detection timing;
an image-taking section which takes the image of a photographic subject by using the emitted light; and
an image processing section which matches the position data indicating the detected position of the apparatus and the image data obtained by the image-taking.

2. The apparatus according to claim 1, wherein the image-taking section has an area image sensor which includes a plurality of pixel groups having different exposure periods from each other; and
the light emitting timing is the timing synchronized with the detection timing in the period in which all pixel groups of the area image sensor are in an exposure state.

3. The apparatus according to claim 1, wherein the detection timing is the timing of every preset time elapse.

4. The apparatus according to claim 1, further comprising:
an interface section which is connected to a computer; and
a user instructions input section which transmits a signal according to the detected position of the apparatus to the computer as a signal indicating user instructions.

5. A method comprising:
(a) detecting a position at predetermined detection timing;
(b) making a light source emit light at light emitting timing synchronized with the detection timing;
(c) taking the image of a photographic subject by using the emitted light; and
(d) matching the position data indicating the detected position and the image data obtained by the image-taking.

6. A recording medium, having a program for actualizing in a computer
the function of detecting a position at predetermined detection timing;
the function of making a light source emit light at light emitting timing synchronized with the detection timing;
the function of taking the image of a photographic subject by using the emitted light; and
the function of matching the position data indicating the detected position and the image data obtained by the image-taking.
